(19) United States
(12) Patent Application Publication
(10) Pub. No.: US 2004/0098419 A1
(43) Pub. Date: May 20, 2004

(54) Method and apparatus for a migration assistant

(75) Inventors: David F. Bantz, Chappaqua, NY (US); Thomas E. Chefalas, Somers, NY (US); Alexei A. Karve, Mohegan Lake, NY (US); Steven J. Mastrianni, Unionville, CT (US); Ajay Mohindra, Yorktown Heights, NY (US); Dennis G. Shea, Ridgefield, CT (US)

Correspondence Address: Intellectual Property Law, IBM Corporation, Dept. 39-240, T.J. Watson Research Center, 1101 Kitchawan Road / Route 134, Yorktown Heights, NY, 10598, US

(73) Assignee: INTERNATIONAL BUSINESS MACHINES CORPORATION, Armonk, NY

(21) Appl. No.: 10/298,355

(22) Filed: Nov. 18, 2002

(51) Int. Cl. G06F 12/00

(52) U.S. Cl. 707/203

(57) ABSTRACT

Consistent and systematic location of program files and associated data files is enhanced by use of a software module that carries out migration of program files and associated data files in accordance with a stored set of policies on what programs are acceptable: what versions are current and/or obsolete and what locations for program and data files are acceptable. An optional feature is a resident program that monitors the installation process for programs and the creation process for files and carries out organization policies with regard to whether the program in question is approved and/or whether the file in question is located in an approved location.

### TECHNICAL FIELD

The field of the invention is that of systems of computers that are periodically upgraded and have software and data migrated to a new computer.

### BACKGROUND OF THE INVENTION

Software installation and storage on a computer media is typically done on an adhoc basis. Each time a user installs a new software on his computer, or creates a new data file, the user is free to select the location folder to install into. For example, when installing Lotus Notes, a user is free to install the application in a folder that is different than the default folder C:\Lotus\Notes. Further, a user is free to call the new folder anything he feels like. Similarly, when creating data files through the software applications, a user is free to save the files in which any folder of his choosing. For example, a Microsoft Word document file called MyReport.doc, can be stored in any folder, for example C:\My Documents\.

Even though such flexibility is well intentioned, it creates many problems when the user wants to migrate to a new system. Software and data migration is needed when a user replacing his existing system with a new system. The problems occur in terms of determining which application and data files to migrate to the new system without loss of any data from the original system. More often, a user has to browse through the entire storage media to determine and identify data files that need to be migrated to the new system. This approach to system migration costs both time and money.

One way to alleviate the migration problem is to use policies such as IT best practices when performing software installation on the system. IT best practices are documented strategies and tactics employed by system administrators to reduce the cost associated with managing and administering systems. Best practices include file system structure, naming and location of data and program files, approved versioning of programs, guaranteed presence or absence of certain programs, options selection for programs, including forcing program/data access from shared servers, Microsoft Active Directory settings and other practices designed to ease maintenance of software and hardware. Following best practices requires that the software programs and data files be located in predetermined folders. It is easier to migrate a system that follows best practices because the user knows exactly which folders and data files to migrate.

Several companies have introduced products to facilitate system migration. Off these products, two are well known—IBM's System Migration Assistant and PowerQuest's Migration manager. The two applications assist IT personnel in upgrading users to new computers. The software migration application provides for selective or mass migration of data, selective migration of system personality, connectivity settings, end-user data files, and additional settings required by an application on the target computer. These products work in a two step manner. In the first phase or “capture” phase, the software captures the system software and user profile setting and stores them in a profile file. In the second, or “apply” phase, the program reads information from the profile file and applies them to the new machine.

Even though the products help users migrate, they suffer from several limitations. First, the products are rigid in their behavior as they follow predetermined policies, which are not necessarily best practices. Hence during system migration, the products migrate all of the data from one computer to another, or the user has to specify the location of the folders and software applications to migrate. During system migration, the data and applications are moved from the older computer to the new computer without regard to the location of the new applications. If the user's data is simply migrated with the same structure, the new computer configuration (both application and data files) will be as disorganized as the original system.

### SUMMARY OF THE INVENTION

The invention relates to a method of migrating programs and data by a program following stored policies.

A feature of the invention is the ability of the user to customize the parameters of the migration.

A feature of the invention is the following by the migrating program of policies set by the organization.

Another feature of the invention is the provision of a resident program that monitors the installation of new programs and/or data files.

Another feature of the invention is the control by the monitoring program of the installation of new programs and/or data files.

### BRIEF DESCRIPTION OF THE DRAWINGS

FIG. 1. Illustrates the system configuration for performing a migration.

FIG. 2. Illustrates the data structure that stores the rules associated with migration polices.

FIG. 3. Illustrates the flowchart for the migration assistant program.

FIG. 4. Illustrates the system configuration for the module that enforces policies.

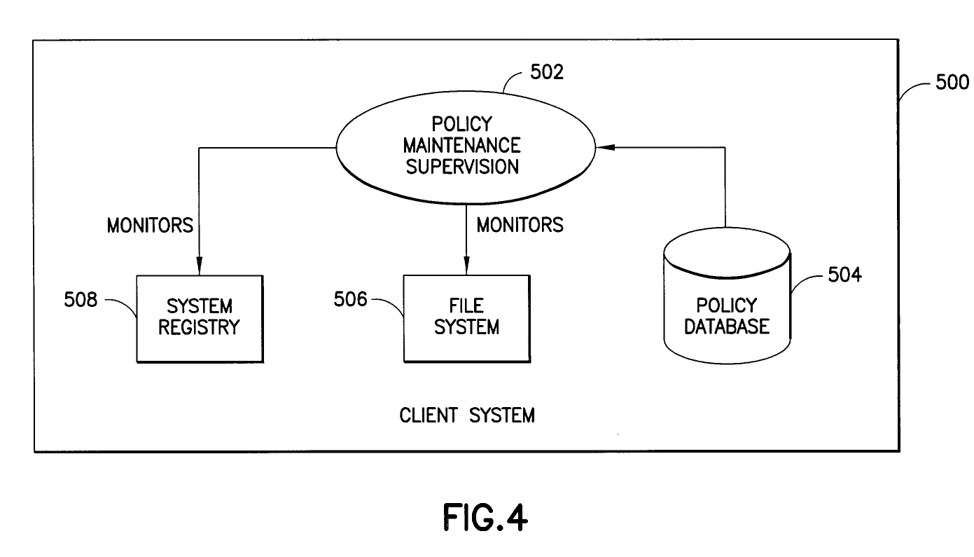

FIG. 5. Illustrates the flowchart for the policy enforcement module.

### DETAILED DESCRIPTION OF THE PREFERRED EMBODIMENT

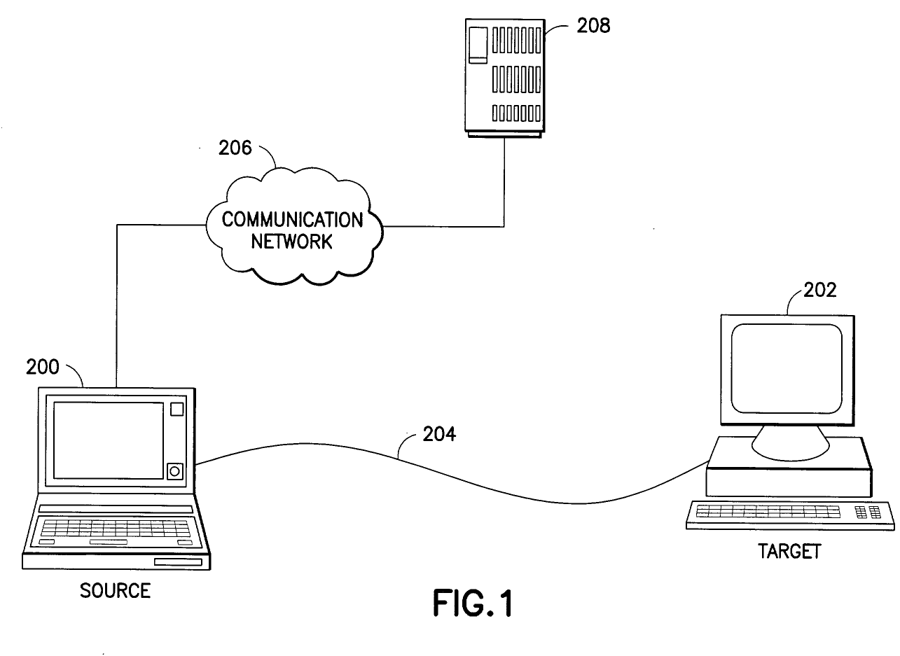

FIG. 1 shows a typical system configuration for performing migration. The illustrative configuration consists of a laptop computer 200 from which data and applications are to be moved, designated as SOURCE. The computer has an operating system such as Windows 95, Windows 98, Windows 2000, Windows CE, Windows NT, or Linux. The SOURCE computer is connected to a desktop computer 202, designated as the TARGET, to which the applications and data are to be migrated under control of a migration program having available to it the organization's migration policies. The two computers are connected to each other using a communication medium 204, shown as a direct line, which can be embodied either as a serial link, a parallel link, or a connection through a network. The SOURCE computers can also be connected to a server 208 via a communication network 206.

Server 208 provides access to the system migration assistant along with latest policies that a user can choose to customize. The server may be internal to the organization or may be a Web site located on the Internet. The relevant policies can either be downloaded to the SOURCE computer from a server on the Internet, or can be used directly off the web site located on the Internet. The policies may optionally be freely customized by the user, customized within constraints set in the policies, or not altered at all.

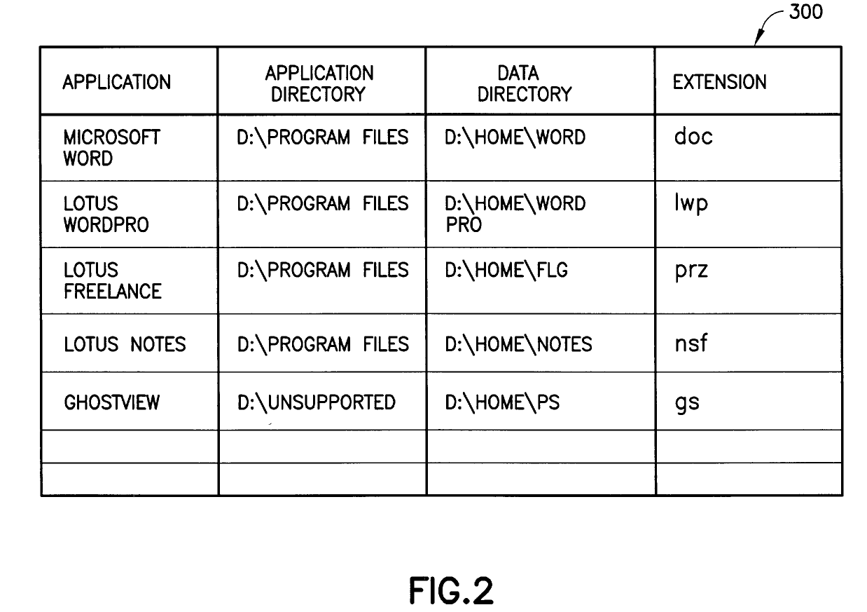

FIG. 2 shows the data structure 300 that specifies the rules associated with policies. The data structure is populated by reading a configuration text file that is distributed with the migration assistant application. The data structure consists of four fields—(1) Name of the application, (2) Application directory, (3) Data directory, and (4) Extensions of the data files associated with the application.

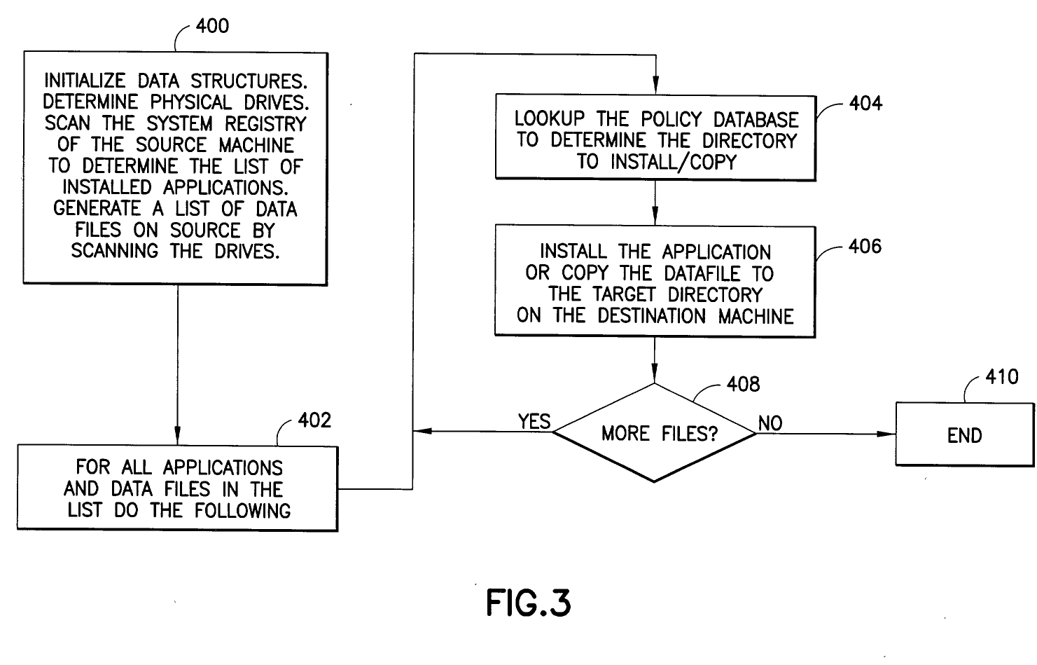

FIG. 3 shows the flowchart for the migration assistant to perform migration based on customizable policies such as IT best practices.

Step 1.

When the migration assistant software is first “launched” on the SOURCE machine, it initializes its POLICY DATABASE data structure and reads the rules from the configuration file specified in FIG. 2. The rules contained in the rule database describe how the applications and data files should be migrated. This information includes, but is not limited to, prerequisites for migration, and migration policies that may be established beforehand by company guidelines or directives. These policies are set or modified by a policy editor that is not part of this invention. A policy could be applied to a single object, or a group of objects. A policy might state, for example, that the XYZ application should be upgraded to version 1.7, and that in order to run that version, the operating system must first be upgraded to version 5.1. This is an example of a prerequisite. Another policy might state that under no circumstances are accounting record files and applications are to be moved to the new system. This would be an example of a restriction. Another policy might dictate that an application “OriginalApp” be replaced with another application “ReplacementApp” and all appropriate data files for OriginalApp be converted to the format used by the ReplacementApp. The last example is an example of a replacement. Still another policy might dictate that under new corporate guidelines, users are not to have a particular application installed at any time, in this case the application would be removed from the set of programs and data that are to be migrated at migration time. The policy might also state that the company is moving to “ReplacementApp” from “OriginalApp” for word processing. In this case, the migration assistant collects all the word processing files on the user's machines and converts them to “ReplacementApp” format. The new files are then migrated to the new system with the new applications.

Step 2.

Using the operating system services for identifying devices attached to the computer, the migration assistant queries the operating system services to obtain a list of the storage devices attached to the SOURCE computer. In the Windows operating system, this is accomplished using the Windows operating system Application Programming Interface, or API, or by using the Windows Management Instrumentation, or WMI, API functions. The following code fragment accomplishes the task in Windows operating system

Set DriveSet=GetObject(“winmgmts:”).ExecQuery(“select*from Win32_LogicalDisk”)

Step 3.

Further, using WMI API functions, the migration assistant scans the SOURCE computer system to determine the names of the applications that are currently installed on that computer, noting the storage location of these applications and their associated data and configuration files. Information returned by the following code fragment is correlated with information returned by other WMI calls to identify list of all installed applications and their associated data and configuration files in the system.

Set ApplicationSet=GetObject(“winmgmts:”).ExecQuery(“select*from Win32_InstalledSoftwareElement”)

Step 4.

After all the applications have been identified, using the rules and policies acquired in Step 1, the migration assistant selects each application in the list of applications gathered in Step 3 and searches the rules and policies to determine if an application should be deleted, replaced, or moved, and if so stated by the policies, determines where the application should be moved to on the DESTINATION computer. For example, the rule may state that the application should be moved to the “Program Files” folder on the DESTINATION computer, and that the data and configuration files for the application should be placed in the “My Documents” folder on the DESTINATION computer. The policy may also include a policy directing that the application be updated to a later version before or after migration. If the application must be upgraded before moving, the migration assistant contacts a web site (or internal server) specified in the rules and policies database from Step 1 and performs the update of the application. The application that is migrated, whether from the SOURCE or a more recent version from the server, will be referred to in the claims as an “approved version of application program on the first computer”; i.e. the program is an application program on the first computer and the approved version is one of the copy on the first computer or the reference copy on the server. Depending on the outcome of the update, the migration assistant might then begin the migration of the application and its associated data and configuration files to the DESTINATION computer system.

Step 5.

The migration assistant contacts the DESTINATION computer to determine if the application is already installed on the DESTINATION computer. If so, the migration assistant commands the DESTINATION computer to perform an uninstall of the application if required by the rules and policies from Step 1. Such an action may be needed if the policy states that the application should be upgraded to a new version as part of migration. The rules and policies may also state that additional actions be performed on its behalf on the DESTINATION computer to ready that computer to receive the migrated or updated application and its associated data and configuration files.

Step 6.

Once the prerequisite actions have been performed on the DESTINATION computer, the migration assistant proceeds with the migration of the application to the DESTINATION computer system. For each application in the list obtained in Step 3, the migration assistant performs steps 4, 5, and 6 until there are no more applications or data to be migrated.

For installing applications on the DESTINATION computer, the invention uses a utility such as the Microsoft Installer utility.

Other examples of similar actions that may be performed based on rules and policies are filtering out (not migrating) bad programs, detecting orphaned data, repairing corrupted files, converting data files from one format to another, encrypting data files, and repairing a defective configuration.

Step 7.

An optional feature of the invention is that, if specified by the rules and policies acquired in Step 1, the migration assistant will download to the DESTINATION computer an application that runs continuously while the system is being used and enforces the policies specified by the rules and policies for the DESTINATION computer. In accordance with these policies, the migration assistant may also create or download to the DESTINATION computer a digital certificate or encryption key to be used by the DESTINATION computer to access the migrated applications and data.

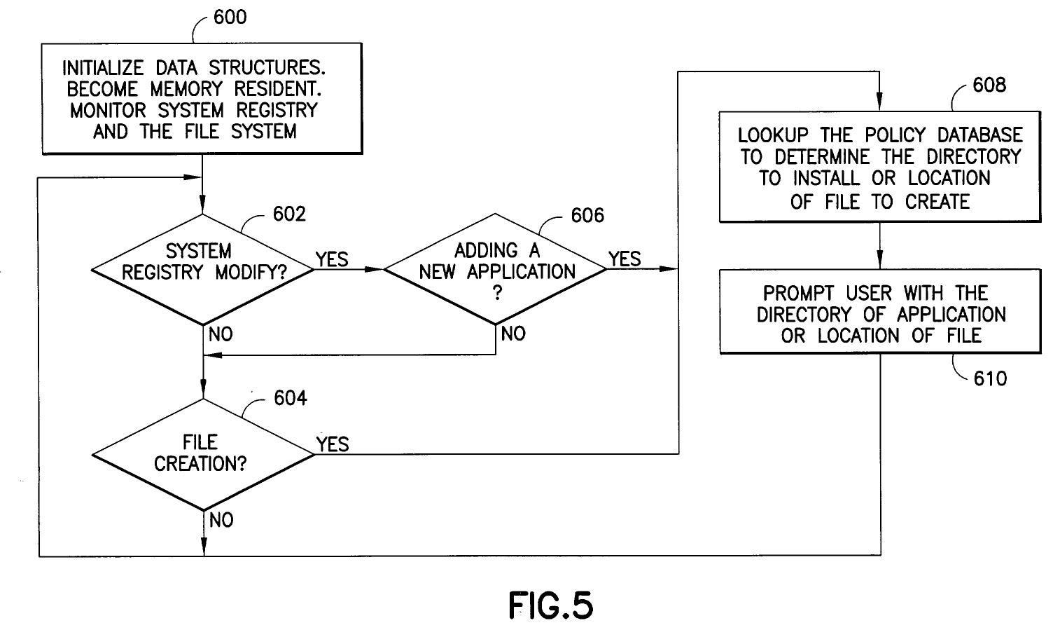

FIG. 5 shows the system configuration for the module that enforces policies. The client system 500 consists of the software module called Policy Maintenance Supervisor (PMS) 502. It uses a policy database 504 as input to provide policies relating to current best practices. The Policy Maintenance Supervisor monitors the system registry 508 and the file system 506 for new software installation and new file creation.

FIG. 6 shows the flowchart for the PMS software module. When the PMS is launched, it initializes POLICY DATABASE data structure 600 and reads the rules from the configuration file specified in FIG. 3. Next, the PMS becomes memory resident monitoring changes in the System Registry to determine if new applications are being installed, and monitoring changes to the file system for new file creation. In the preferred embodiment, this is accomplished by the PMS application by registering itself as a listener to _InstanceCreationEvents in WMI. The following code fragment written in MOF (Managed Object Format) language of WMI illustrates the steps of registration as an event listener.

#pragma namespace (“\\\\.\\Root\\cimv2”)
// register me as a Physical Event Consumer Provider.
instance of_Win32Provider as $P
{

Name = “CmdLineEventConsumer”;
Clsid = “{31704FFF-6B85-11d1-ADAD-00AA00B8E05A}”;

```
};
instance of_EventConsumerProviderRegistration
{
  Provider = $P;
  ConsumerClassNames = {“CmdLineEventConsumer”};
};
class CmdLineEventConsumer : _EventConsumer
{
  [key] string Name;
};
// Make an instance. Make more if want.
instance of CmdLineEventConsumer
{
  Name = “PolicymaintenanceHandler”;
};
instance of _EventFilter
{
```

Name = “PolicymaintenanceFilter”;
QueryLanguage=“WQL”;
Query=“select * from _InstanceCreationEvent”;

```
};
// register for the event.
instance of _FilterToConsumerBinding
{
  Consumer =
“CmdLineEventConsumer.Name=\“PolicymaintenanceHandler\””;
  Filter = “ _EventFilter.Name=\“PolicymaintenanceFilter\””;
};
```

After the PMS registers itself on a system, any event related to the installation of a new software or a creation of a new data files is reported to the PMS. Whenever any change occurs, in step 602, the PMS determines if the change is to the system registry. If the answer is YES then the PMS determines in step 606 if a new application is being added. If the answer to this question is YES then PMS moves to step 608 described below. If in step 602 or 606, the PMS determines that no new application is being added or the system registry is unchanged, if determines if the file system is being modified via file creation event. If the answer is YES then PMS moves to step 608 described below. If no new files are being created then the PMS waits for the next event to occur in step 602.

In step 608, the PMS looks up the POLICY DATABASE to determines if there are any policies associated with the installation of that application. For example, a policy might require that the application be installed in a particular folder or directory. When a policy information is found, the PMS prompts the user with all appropriate policy requirements that affect that the installation of that software application. When the determination is made, in step 608, the PMS prompts the user with the recommended directory for application installation or new file creation based on IT best practices.

Similarly, the PMS also registers to monitor any _InstanceModificationEvent and _InstanceDeletionEvent generated by WMI. Monitoring of these events permits the PMS to determine if any modification or removal of software or data files is governed by any specific policy. If any actions as a result of the policy need to be taken then the PMS takes those actions. These action may include preventing files or software from being deleted due to dependencies on other files, and applications. For example, a policy associated with a particular file may result in the PMS prompting the that a file being deleted is a critical system configuration file and deletion of the file may result in a particular software application from starting.

An advantageous feature of the invention is that by associating policy information with different objects (software applications, files, folders, user preferences), the task of software migration, and systems management becomes very flexible and customizable.

In the provided embodiment, the policy database coexists with the PMS on the client machine. In another embodiment, the policy database could be centrally administered and shared by several PMSs via replicas residing on client machines.

Now that the invention has been described by way of the preferred embodiment, various modifications and improvements will occur to those of skill in the art. Thus, it should be understood that the preferred embodiment has been provided as an example and not as a limitation. The scope of the invention is defined by the appended claims.

What is claimed is:

1. A method for migrating software and data files from a first computer to a second computer comprising the steps of:
identifying software objects, said software objects comprising at least programs and data files;
reading stored policy data associated with changes to said software objects, said policy data comprising at least a list of approved software and storage locations for data associated therewith; and
migrating software and data files subject to said policy data.

2. A method according to claim 1, in which said step of migrating comprises, for a set of application programs, comparing a first version of an application program on said first computer with a reference version in said policy data and copying said first version to said second computer when it is the same as said reference version and copying said reference version to said second computer when said first version is older than said reference version.

3. A method according to claim 1, in which said step of migrating comprises a step of requesting a command from a user when an application program is not found in said list of approved software.

4. A method according to claim 1, in which said step of migrating comprises migrating only application programs found in said list of approved software.

5. A method according to claim 2, in which said step of migrating comprises copying data associated with an older version of an application program to said second computer in association with said reference version.

6. A method according to claim 1, in which said step of migrating comprises, for a set of application programs, copying an approved version of an application program on said first computer to a location on said second computer specified in said policy data.

7. A method according to claim 2, in which said step of migrating comprises, for a set of application programs, copying data associated with an approved version of an application program on said first computer to a data location on said second computer specified in said policy data.

8. An article of manufacture in computer readable form comprising means for performing a method for operating a computer system for migrating software and data files from a first computer to a second computer comprising the steps of:
identifying software objects, said software objects comprising at least programs and data files;
reading stored policy data associated with changes to said software objects, said policy data comprising at least a list of approved software and storage locations for data associated therewith; and
migrating software and data files subject to said policy data.

9. An article of manufacture in computer readable form according to claim 8, comprising means for performing a method for migrating software and data files from a first computer to a second computer, in which said step of migrating comprises, for a set of application programs, comparing a first version of an application program on said first computer with a reference version in said policy data and copying said first version to said second computer when it is the same as said reference version and copying said reference version to said second computer when said first version is older than said reference version.

10. An article of manufacture in computer readable form according to claim 8, comprising means for performing a method for migrating software and data files from a first computer to a second computer, in which said step of migrating comprises a step of requesting a command from a user when an application program is not found in said list of approved software.

11. An article of manufacture in computer readable form according to claim 8, comprising means for performing a method for migrating software and data files from a first computer to a second computer, in which said step of migrating comprises migrating only application programs found in said list of approved software.

12. An article of manufacture in computer readable form according to claim 8, comprising means for performing a method for migrating software and data files from a first computer to a second computer, in which said step of migrating comprises, for a set of application programs, copying an approved version of an application program on said first computer to a location on said second computer specified in said policy data.

13. An article of manufacture in computer readable form comprising means for performing a method for operating a computer system for controlling the installation of software objects, said software objects comprising at least programs and data files, comprising the steps of:
monitoring the installation process of software objects on said computer;
reading stored policy data associated with changes to said software objects, said policy data comprising at least a list of approved software and storage locations for data associated therewith; and
affecting the installation of software and data files subject to said policy data.

14. An article of manufacture in computer readable form according to claim 13, comprising means for performing a method for operating a computer system for controlling the installation of software objects, in which said step of affecting the installation comprising presenting a set of at least one prompt from said policy data to a user.

15. An article of manufacture in computer readable form according to claim 13, comprising means for performing a method for operating a computer system for controlling the installation of software objects, in which said step of affecting the installation comprises preventing the installation of application programs not listed in said policy data.

16. An article of manufacture in computer readable form according to claim 13, in which said step of presenting a set of at least one prompt comprises at least specifying an approved location for program installation and an approved location for data installation from said policy data to a user.

17. An article of manufacture in computer readable form according to claim 13, in which said step of presenting a set of at least one prompt comprises at least warning a user that deleting a file will affect the operation of at least one software object.

18. A method according to claim 1, in which said step of migrating comprises for a set of application programs, comparing an application program on said first computer for performing a function with a reference application program for performing said function listed in said policy data and copying said first program to said second computer when it is the same as said reference program and copying said reference program to said second computer when said first program is other than said reference program and converting data associated with an application program not listed in said policy data to an approved format and copying said data to said second computer in association with said reference program.

19. A method according to claim 1, in which said step of migrating comprises, for a set of application programs, copying an approved application program for performing a function to a location on said second computer specified in said policy data and converting data files associated with another application program for performing said function that are on said first computer to the format of said approved application program and copying such converted files to said second computer.

20. A method according to claim 1, in which said step of migrating comprises, for a set of application programs, removing from the set of programs to be copied an application program that is specified in said policy data as being excluded from the list of approved programs.
